(19) United States
(12) Patent Application Publication
(10) Pub. No.: US 2015/0186320 A1
(43) Pub. Date: Jul. 2, 2015

(54) BACKWARD COMPATIBLE NEW FORM FACTOR CONNECTOR

(71) Applicants: James E. Jaussi, Hillsbro, OR (US); Bryan K. Casper, Portland, OR (US); Stephen R. Mooney, Beaverton, OR (US); Howard L. Heck, Hillsboro, OR (US); Steven Mcgowan, Portland, OR (US)

(72) Inventors: James E. Jaussi, Hillsbro, OR (US); Bryan K. Casper, Portland, OR (US); Stephen R. Mooney, Beaverton, OR (US); Howard L. Heck, Hillsboro, OR (US); Steven Mcgowan, Portland, OR (US)

(21) Appl. No.: 14/142,208

(22) Filed: Dec. 27, 2013

(51) Int. Cl. G06F 13/40

(52) U.S. Cl. CPC G06F 13/4068

(57) ABSTRACT

A computing system can include an electronic device including a controller and a new form factor (NFF) receptacle. The computing system can also include a legacy-compatible adapter coupled to the NFF receptacle to couple the electronic device to a second electronic device. The second electronic device can include a legacy connector. The adapter can include a voltage converter to convert voltage signals between the NFF receptacle of the electronic device and the legacy connector of the second electronic device.

### TECHNICAL FIELD

The present techniques relate generally to input/output (I/O) connectors. In particular, the present techniques relate to a backward compatible new form factor (NFF) connector.

### BACKGROUND

Computing devices can include connector receptacles to connect the computing devices to other devices. Using connectors that are compatible with these connector receptacles, a computing device can be connected to other electronic devices, such as I/O devices. These electronic devices can include a media device, a cellular phone, a display monitor, a memory device, a memory card reader or any other type of device.

### BRIEF DESCRIPTION OF THE DRAWINGS

Certain examples are described in the following detailed description and in reference to the drawings, in which:

FIG. 1 is a block diagram of an example of a computing system;

FIG. 2 is an illustration of an example of a computing system;

FIG. 3A is a block diagram of an example of a legacy-compatible adapter;

FIG. 3B is a block diagram of another example of a legacy-compatible adapter;

FIG. 3C is a block diagram of a further example of a legacy-compatible adapter;

FIG. 4 is a block diagram of another example of a computing system;

FIG. 5 is a process flow diagram of an example of a method of coupling an electronic device to a host electronic device; and

FIG. 6 is a process flow diagram of an example of another method of coupling an electronic device to a host electronic device.

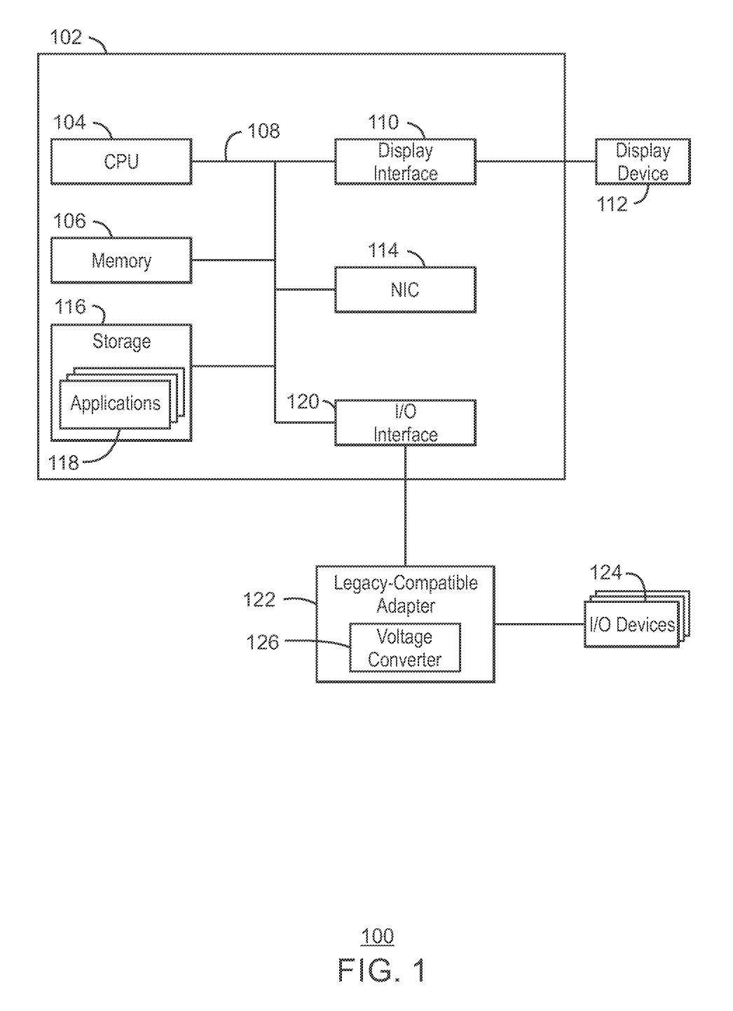

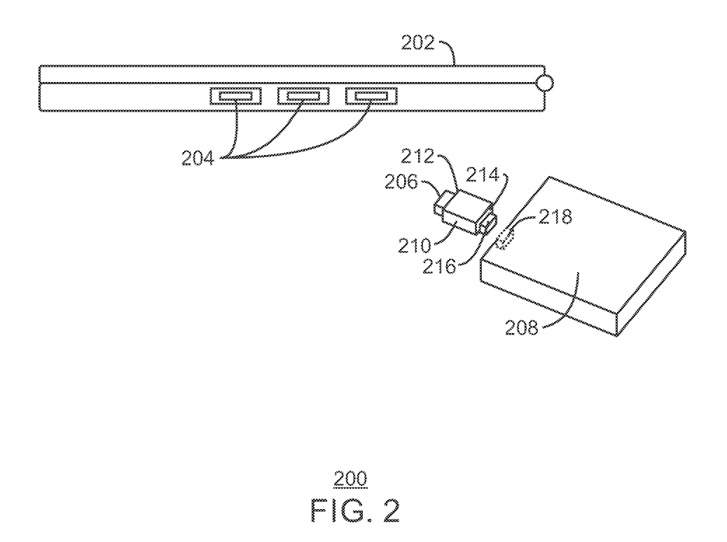

The same numbers are used throughout the disclosure and the figures to reference like components and features. Numbers in the 100 series refer to features originally found in FIG. 1; numbers in the 200 series refer to features originally found in FIG. 2; and so on.

### DETAILED DESCRIPTION OF SPECIFIC EMBODIMENTS

Examples disclosed herein provide techniques for backward compatible I/O connectors. As used herein, the term “connector” encompasses both a female connector (i.e., a receptacle) and a male connector (i.e., a plug). A “legacy device” refers to an electronic device that couples to another electronic device via legacy connectors (i.e., outdated connectors) and transfers data using the outdated connector technology. A current new form factor (NFF) device refers to an electronic device employing the most current NFF connector technology.

A new electronic device connector is developed approximately every 15 years. New connectors are designed to meet future bandwidth requirements, as well as to be compatible with outdated, or legacy, connectors. Current universal serial bus (USB) I/O signals use outdated voltage technology which significantly limits future data rate scaling, increases I/O power, and adds cost to future products. For example, high voltage USB 2.0 signals employ higher voltage transistors which drive up manufacturing costs for the silicon chip. In addition, the high voltage USB 2.0 devices decrease the maximum rate at which the pins can operate. For example, the maximum data rate for USB 2.0 is 480 Mb/s.

In order to overcome these limitations, a legacy-compatible adapter including a voltage converter is described. Using the voltage converter, the legacy-compatible adapter supports current USB devices by converting the high-voltage USB signals to low-voltage current signals. The voltage converter utilizes less power that the current USB system and does not limit higher data rates. Additionally, the voltage converter decreases costs of the legacy-compatible adapter. In particular, by removing the high voltage USB signals from a connector, the complementary metal-oxide semiconductor (CMOS) chip does not need to support the higher USB voltages in the connector. In addition, by employing dynamically reconfigurable pins, the pins that communicated with a legacy device can be repurposed to operate at higher speeds, such as 40 Gb/s (i.e., 100× speed improvement) when a new connector is attached.

FIG. 1 is a block diagram of an example of a computing system 100. The computing system 100 can include a host electronic device 102. The host electronic device 102 can be any suitable type of computing system including, for example and without limitation, tablet computer, laptop computer, an ultra-book computer, a cellular phone, such as a smartphone, and the like. The host electronic device 102 can include a central processing unit (CPU) 104 to execute stored instructions, as well as a memory device 106 that stores instructions that are executable by the CPU 104. The CPU 104 can be coupled to the memory device 106 by a bus 108. Additionally, the CPU 104 can be a single core processor, a multi-core processor, or any number of other configurations. Furthermore, the host electronic device 102 can include more than one CPU 104.

The memory device 106 can include random access memory (RAM), read only memory (ROM), flash memory, or any other suitable memory systems. For example, the memory device 106 can include dynamic random access memory (DRAM). The CPU 104 can be linked through the bus 108 to a display interface 110 to connect the host electronic device 102 to a display device 112. The display device 112 can include a display screen that is a built-in component of the host electronic device 102. The display device 112 can also include a computer monitor, television, or projector, among others, that is externally connected to the host electronic device 102.

A network interface card (NIC) 114 can connect the host electronic device 102 through the system bus 108 to a network (not depicted). The network (not depicted) can be a wide area network (WAN), local area network (LAN), or the Internet, among others. In an example, the host electronic device 102 can connect to a network via a wired connection or a wireless connection.

The host electronic device 102 also includes a storage device 116. The storage device 116 is a physical memory such as a hard drive, an optical drive, a thumbdrive, a secure digital (SD) card, a microSD card, an array of drives, or any combinations thereof, among others. The storage device 116 can also include remote storage drives. The storage device 116 includes any number of applications 118 that are configured to run on the host electronic device 102.

The CPU 104 can also be connected through the bus 108 to an input/output (I/O) device interface 120 configured to connect the host electronic device 102 via a legacy-compatible adapter 122 to one or more I/O devices 124. The I/O device interface 120 can scale across a wide range of data rates to accommodate an I/O device including a current new form factor (NFF) connector, as well as a device including a legacy connector.

The legacy-compatible adapter 122 can include a first surface and a second surface. The first surface can include an NFF connector and the second surface can include a legacy connector. The NFF connector can be an NFF receptacle or an NFF plug and the legacy connector can be a legacy receptacle or a legacy plug. The legacy-compatible adapter 122 can include a voltage converter 126 to convert signal voltages between the NFF connector and the legacy connector. The voltage converter 126 can be an active silicon within the legacy-compatible adapter 122 to level shift the voltage signals between the NFF connector and the legacy connector. In an example, the legacy connector can be a USB connector, a USB 2.0 connector, or a USB 3.0 connector, among others. The voltage converter 126 can isolate, and convert, the high-voltage USB signals to low voltage NFF signals. This isolation provides a means for the NFF signals to be defined for high speed performance while maintaining interoperability with legacy devices, such as USB devices, without burdening the NFF connector with outdated legacy voltage technology.

The I/O devices 124 can include, for example, a keyboard and a pointing device, wherein the pointing device can include a touchpad or a touchscreen, among others. The I/O devices 124 can also include a tablet computer, a cellular phone, such as a smartphone, a storage device, and a personal digital assistant (PDA), among others. The I/O devices 124 can be built-in components of the host electronic device 102, or can be devices that are externally connected to the host electronic device 102.

It is to be understood the block diagram of FIG. 1 is not intended to indicate that the computing system 100 is to include all of the components shown in FIG. 1 in every case. Further, any number of additional components can be included within the computing system 100, depending on the details of the specific implementation.

FIG. 2 is an illustration of a computing system 200. The computing system 200 includes a first electronic device 202, such as host electronic device 102. The first electronic device 202 can be any suitable type of electronic device, such as a tablet computer, an ultra-book, or a hand-held device, among others. The first electronic device 202 can include a new form factor (NFF) receptacle 204. The first electronic device 202 can include a single NFF receptacle 204 or multiple NFF receptacles 204. In an example, the first electronic device 202 can include an NFF receptacle 204 and a legacy receptacle, such as a USB receptacle. The NFF receptacle 204 is to receive an NFF plug to couple a second electronic device 208 to the first electronic device 202. In an example, the NFF plug 204 can be included in the second electronic device 208 such that the NFF plug 204 is integrated into the second electronic device. In another example, the NFF plug 204 can be included in a legacy-compatible adapter 210.

The legacy-compatible adapter 210 can include a first surface 212 including the NFF plug 204. The legacy-compatible adapter 210 can also include a second surface 214 including a legacy connector 216. The legacy connector 216 can be a legacy receptacle or a legacy plug. The legacy connector 216 is adapted to couple to a legacy connector 218 included in the second electronic device 208. For example, the legacy connector 216 can be a legacy plug to be received in a legacy receptacle (legacy connector 218).

It is to be understood the illustration of FIG. 2 is not intended to indicate that the computing system 200 is to include all of the components shown in FIG. 2 in every case. Further, any number of additional components can be included within the computing system 200, depending on the details of the specific implementation.

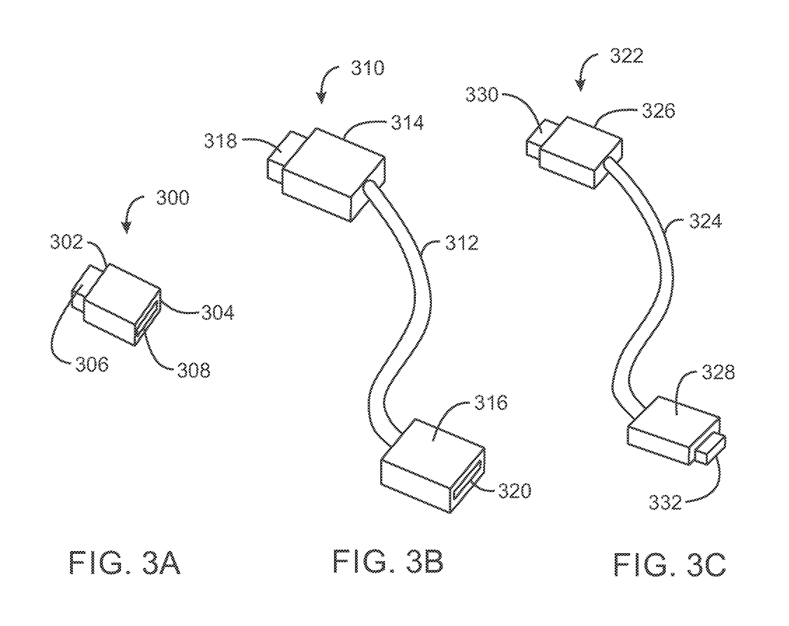

FIG. 3a is a block diagram of an example of a legacy-compatible adapter 300. The legacy-compatible adapter 300 is to couple a first electronic device to a second electronic device. For example, the legacy-compatible adapter 300 can couple a legacy device to a device including a current NFF connector. In another example, the legacy-compatible adapter 300 can couple an electronic device including a current NFF connector to another electronic device including a current NFF connector.

The legacy-compatible adapter 300 can include a first surface 302 and a second surface 304. The first surface 302 can include a new form factor (NFF) plug 306. It is to be understood that while the new form factor (NFF) plug is described as a plug here, the NFF plug could also be an NFF receptacle. The second surface 304 can include a legacy receptacle 308. The legacy receptacle 308 is to receive a legacy plug to connect a legacy electronic device to another electronic device. In an example, the legacy device can include a USB device, a USB 2.0 device, or a USB 3.0 device, among others.

It is to be understood the block diagram of FIG. 3a is not intended to indicate that the legacy-compatible adapter 300 is to include all of the components shown in FIG. 3a in every case. Further, any number of additional components can be included within the legacy-compatible adapter 300, depending on the details of the specific implementation.

FIG. 3b is a block diagram of another example of a legacy-compatible adapter 310. The legacy-compatible adapter 310 can include a cable 312. The cable 312 can include a first end 314 and a second end 316. The first end 314 can include an NFF plug 318 to be received in an NFF receptacle of a first electronic device. The second end 316 can include a legacy receptacle 320 to receive a legacy plug of a second electronic device. The legacy-compatible adapter 310 can couple the first electronic device, a current NFF device, to a legacy device. In an example, the legacy receptacle 320 can be a USB receptacle, a USB 2.0 receptacle, or a USB 3.0 receptacle, among others.

It is to be understood the block diagram of FIG. 3b is not intended to indicate that the legacy-compatible adapter 310 is to include all of the components shown in FIG. 3b in every case. Further, any number of additional components can be included within the legacy-compatible adapter 310, depending on the details of the specific implementation.

FIG. 3c is a block diagram of a further example of a legacy-compatible adapter 322. The legacy-compatible adapter 322 can include a cable 324. The cable includes a first end 326 and a second end 328. The first end can include an NFF plug 330 to be received in an NFF receptacle of an electronic device. The second end 328 can include a legacy plug 332 to be received in a legacy receptacle of a second electronic device.

It is to be understood the block diagram of FIG. 3c is not intended to indicate that the legacy-compatible adapter 322 is to include all of the components shown in FIG. 3c in every case. Further, any number of additional components can be included within the legacy-compatible adapter 322, depending on the details of the specific implementation.

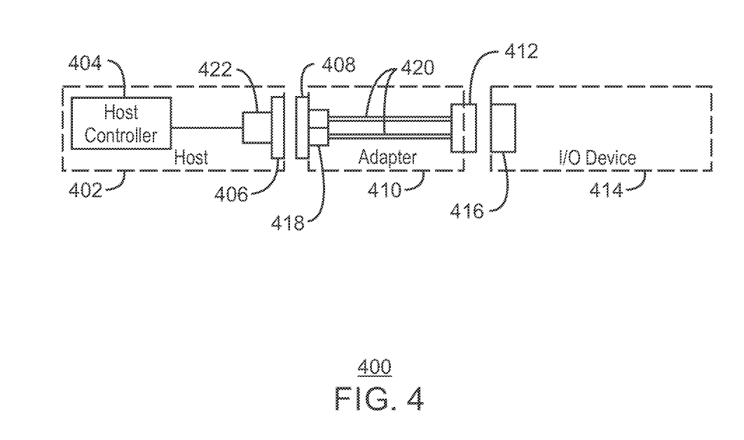

FIG. 4 is a block diagram of another example of a computing system 400. The computing system 400 can include a host electronic device 402. The host electronic device 402 can be any suitable type of electronic device, such as a tablet computer, a smartphone, or a hand-held device, among others. The host electronic device 402 can include a host controller 404. The host electronic device 402 can also include a current new form factor (NFF) connector 406. The NFF connector 406 can be an NFF plug or an NFF receptacle. The NFF connector 406 can be adapted to be received in an NFF connector or to receive an NFF connector. For example, the NFF connector 406 can be an NFF receptacle adapted to receive an NFF plug 408 of a legacy-compatible adapter 410. The adapter 410 can include a legacy connector 412. The legacy connector 412 can be adapted to couple an I/O device 414 to the adapter 410 via a legacy connector 416 of the I/O device 414. For example, the legacy connector 412 can be a legacy plug to be received in a legacy receptacle (legacy connector 416). In another example, the legacy connector 412 can be a legacy receptacle to receive a legacy plug (legacy connector 416). In an example, the I/O device can be a USB device, a USB 2.0 device, or a USB 3.0 device, among others.

The adapter 410 includes a voltage converter 418 to convert voltage signals between the I/O device 414 and the host electronic device 402 when there is a difference in voltages between the I/O device signals and the host electronic device signals. The voltage converter 418 can be an active silicon device and can be included in the NFF connector 408 or the legacy connector 412. For example, the I/O device 414 can include high-voltage signals, such as USB signals, and the host electronic device 402 can include low-voltage signals. The voltage converter 418 can convert the high-voltage signals to the low-voltage signals. By employing the voltage converter 418, the legacy-compatible adapter 410 can meet bandwidth requirements of the current NFF connectors without relying on outdated voltage technology.

The adapter 410 can also include data lanes 418 to transfer data between the host electronic device 402 and the I/O device 414. The data lanes 418 can support multiple protocols and can be assigned based on a determined protocol and the capabilities of the I/O device 414 and the host electronic device 402. For example, the data lanes 418 can be dynamically assigned based on a determined protocol. For example, when the I/O device 414 is a USB device, the data lanes can be assigned to communicate via a USB protocol. For example, a data lane 420 can be assigned as a High-Speed data lane and another data lane 420 can be assigned as a Super-Speed data lane. In another example, the I/O device 414 can be disconnected from the adapter 410 and another I/O device can be coupled to the legacy connector 412. The data lanes 420 can be dynamically reassigned based on the determined protocol and can operate at the highest supported data rate.

The host electronic device 402 can also include logic 422 to determine the protocol. The host electronic device 402 can communicate with the I/O device 414 to determine the capabilities of the I/O device 414 and determine the appropriate protocol based of the determination of capabilities.

In another example, the new form factor (NFF) connector 406 can be physically compatible with the legacy connector 416 of the I/O device. In this example, the NFF plug 408 can be shaped physically identically to the adapter legacy connector 412. The pins of the adapter legacy connector 412 can be dynamically reconfigurable. When the I/O device 414 is a legacy device requiring high voltage signals, the pins of the adapter legacy connector 412 can be assigned a legacy protocol compatible with the I/O device 414. Data signals transferred between the host device 102 and the I/O device 414 can be converted between high voltage signals and low voltage signals by the voltage converter 418. When the I/O device 414 is a new form factor device supporting low voltage, high speed signals, the pins can be reassigned to the new form factor I/O device. Low voltage data signals can be transferred between the host electronic device 402 and the I/O device 414 without converting the data signals from high voltage signals to low voltage signals, or vice versa.

It is to be understood the block diagram of FIG. 4 is not intended to indicate that the machine check counter 400 is to include all of the components shown in FIG. 4 in every case. Further, any number of additional components can be included within the machine check counter 400, depending on the details of the specific implementation.

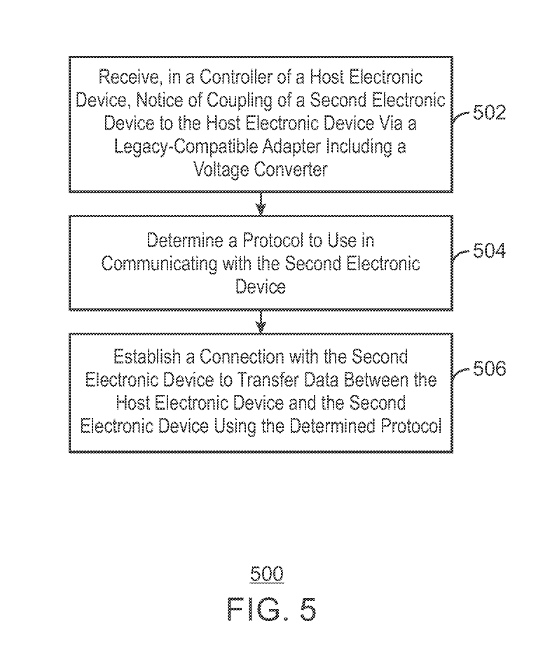

FIG. 5 is a process flow diagram of an example of a method 500 of coupling an electronic device to a host electronic device. At block 502, notice of coupling of a second electronic device to a host electronic device can be received in a controller of the host electronic device. The second electronic device can be coupled to the host electronic device via a legacy-compatible adapter including a voltage converter. The host electronic device can include a current new form factor (NFF) connector, such as a receptacle. The second electronic device can include a legacy connector or an NFF connector. The legacy-compatible adapter can include a first surface including an NFF connector, such as a plug to be received in an NFF receptacle of the host electronic device. The legacy-compatible adapter can also include a second surface including a legacy connector for coupling the adapter to the second electronic device. In an example, the legacy connector can be a USB connector, a USB 2.0 connector, or a USB 3.0 connector, among others.

At block 504, the host controller can determine a protocol to use in communicating with the second electronic device. For example, the host controller can employ logic to determine the protocol. In determining the protocol, the host controller can communicate with the second electronic device via the legacy-compatible adapter. The host controller can determine the capabilities of the second electronic device and if the device is a legacy device. Based on the determination of the capabilities of the second electronic device, the host controller can determine a suitable protocol for communicating with the second electronic device.

At block 506, the host electronic device can establish a connection with the second electronic device to transfer data between the host electronic device and the second electronic device using the determined protocol. If the host electronic device determines that the second electronic device is a legacy device, the legacy-compatible adapter can convert the voltage(s) of the data signal(s) transferring the data.

It is to be understood the process flow diagram of FIG. 5 is not intended to indicate that the method 500 is to include all of the components shown in FIG. 5 in every case. Further, any number of additional components can be included within the method 500, depending on the details of the specific implementation.

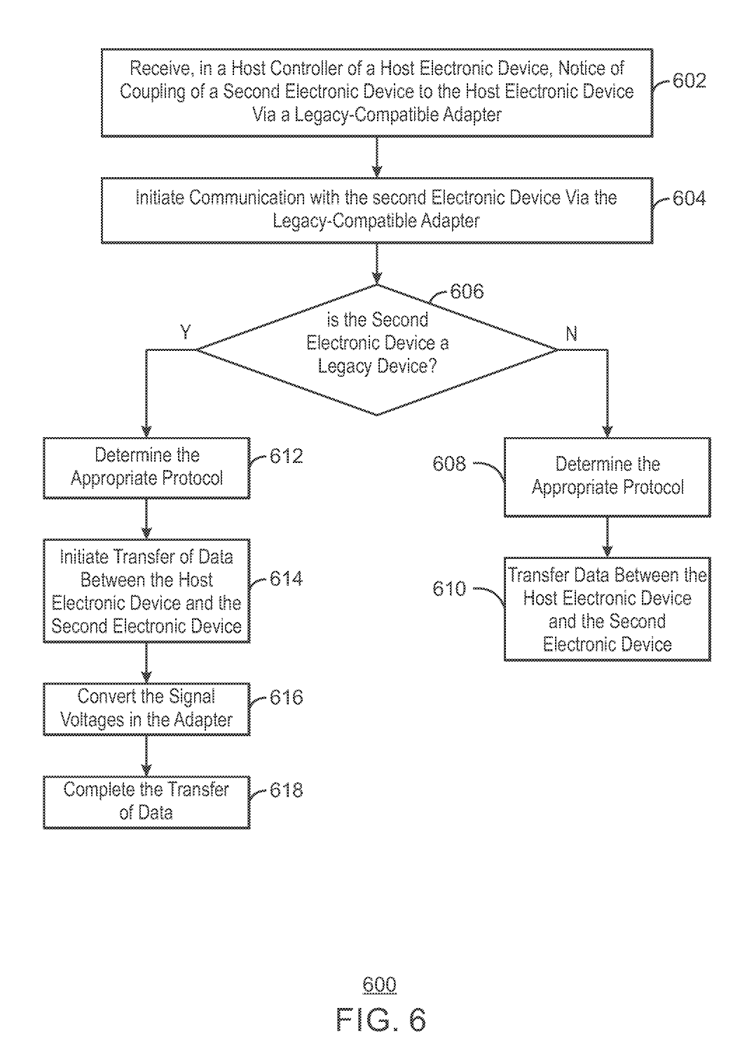

FIG. 6 is a process flow diagram of an example of another method 600 of coupling an electronic device to a host electronic device. At block 602, notice of coupling of a second electronic device to a host electronic device can be received in a controller of the host electronic device. The second electronic device can be coupled to the host electronic device via a legacy-compatible adapter including a voltage converter. The host electronic device can include a current new form factor (NFF) connector, such as a receptacle. The second electronic device can include a legacy connector or an NFF connector. The legacy-compatible adapter can include a first surface including an NFF connector, such as a plug to be received in an NFF receptacle of the host electronic device. The legacy-compatible adapter can also include a second surface including a legacy connector for coupling the adapter to the second electronic device. In an example, the legacy connector can be a USB connector, a USB 2.0 connector, or a USB 3.0 connector, among others.

At block 604, the host controller can initiate communication with the second electronic device via the legacy-compatible adapter. The host controller can initiate communication to determine the capabilities of the second electronic device. At block 606, the host controller can determine if the second electronic device is a legacy device.

If the second electronic device is not a legacy device, at block 608, the host controller can determine the appropriate protocol based on the determined capabilities of the second electronic device. At block 610, data can be transferred between the host electronic device and the second electronic device using the determined protocol.

If the second electronic device is a legacy device, at block 612, the host controller can determine the appropriate protocol based on the determined capabilities of the legacy device. At block 614, the transfer of data between the host electronic device and the second electronic device via the legacy-compatible adapter can be initiated. At block 616, voltages of the data signals transferring the data can be converted by the voltage converter of the legacy-compatible adapter. For example, in transferring data from a USB legacy device to a current NFF host device, the high-voltage of the USB signals can be converted to the low voltage of the NFF signals. At block 618, transfer of the data can be completed.

It is to be understood the process flow diagram of FIG. 6 is not intended to indicate that the method 600 is to include all of the components shown in FIG. 6 in every case. Further, any number of additional components can be included within the method 600, depending on the details of the specific implementation.

### Example 1

A computing system is described herein. The computing system includes an electronic device including a controller and a new form factor (NFF) receptacle. The computing system also includes a legacy-compatible adapter coupled to the NFF receptacle to couple the electronic device to a second electronic device. The second electronic device includes a legacy connector. The adapter includes a voltage converter to convert voltage signals between the NFF receptacle of the electronic device and the legacy connector of the second electronic device.

The legacy connector can include one of a USB connector, a USB 2.0 connector, or a USB 3.0 connector. The adapter can include a cable, the cable including a first end and a second end, the first end including the legacy connector and the second end including the NFF connector. The adapter can couple a first electronic device including an NFF connector to a second electronic device including a legacy connector. The adapter can include a state machine to enumerate capabilities of an electronic device coupled to the adapter. The legacy-compatible adapter can include a new form factor (NFF) connector at a first end and a legacy connector at a second end, the legacy connector physically identical to the new form factor (NFF) connector, wherein the legacy connector is coupled to one of a new form factor (NFF) device or a legacy device, and wherein pins of the legacy connector are to be dynamically assigned to the NFF device or the legacy device. The NFF connector can include an NFF plug and the legacy connector can include one of a USB connector, a USB 2.0 connector, or a USB 3.0 connector.

### Example 2

A legacy-compatible adapter with backward compatibility is described herein. The legacy-compatible adapter includes a first surface including a legacy connector and a second surface including a current new form factor (NFF) connector. The legacy-compatible adapter also includes a voltage converter to shift voltage signals between the legacy connector and the current NFF connector, wherein the legacy-compatible adapter couples an electronic device including a current new form factor (NFF) receptacle to a second electronic device including a legacy connector.

The legacy connector can include one of a USB connector, a USB 2.0 connector, or a USB 3.0 connector. The legacy connector can include a legacy receptacle or a legacy plug. The adapter can include a cable, the cable including a first end and a second end, the first end including the legacy connector and the second end including the NFF connector. The adapter can couple a first electronic device including an NFF connector to a second electronic device including a legacy connector. The voltage converter can include an active silicon in the NFF connector. The adapter can include a state machine to enumerate capabilities of an electronic device coupled to the adapter. The NFF connector can include an NFF plug and the legacy connector can include one of a legacy plug and a legacy receptacle. The first surface can include a new form factor (NFF) connector and the second surface can include a legacy connector at a second end, the legacy connector physically identical to the new form factor (NFF) connector, wherein the legacy connector is coupled to one of a new form factor (NFF) device or a legacy device, and wherein pins of the legacy connector are to be dynamically assigned to

### Example 3

A computing system is described herein. The computing system includes logic to receiver, in a controller of a host electronic device, notice of coupled of a second electronic device to the host electronic device, the second electronic device coupled to the host electronic device via a legacy-compatible adapter including a voltage converter. The computing system also includes logic to determine a protocol to use in communicating with the second electronic device. The computing system further includes logic to establish a connection with the second electronic device to transfer data between the host electronic device and the second electronic device using the determined protocol.

The computing system can further include logic to convert a voltage of a signal from a legacy voltage to a current NFF voltage when the second electronic device includes a legacy connector. Determining the protocol can include determining if the second electronic device includes a legacy connector or a NFF connector. The adapter can include a first surface including an NFF connector and a second surface can include a legacy connector. The NFF connector can include an NFF plug and the legacy connector can include one of a legacy plug and a legacy receptacle. The adapter can include a cable including a first end and a second end, the first end including an NFF connector and the second end including a legacy connector. The second electronic device can include a USB connector, a USB 2.0 connector, or a USB 3.0 connector.

In the foregoing description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the preceding description, various aspects of the disclosed subject matter have been described. For purposes of explanation, specific numbers, systems and configurations were set forth in order to provide a thorough understanding of the subject matter. However, it is apparent to one skilled in the art having the benefit of this disclosure that the subject matter may be practiced without the specific details. In other instances, well-known features, components, or modules were omitted, simplified, combined, or split in order not to obscure the disclosed subject matter.

While the disclosed subject matter has been described with reference to illustrative embodiments, this description is not intended to be construed in a limiting sense. Various modifications of the illustrative embodiments, as well as other embodiments of the subject matter, which are apparent to persons skilled in the art to which the disclosed subject matter pertains are deemed to lie within the scope of the disclosed subject matter.

While the present techniques may be susceptible to various modifications and alternative forms, the exemplary examples discussed above have been shown only by way of example. It is to be understood that the technique is not intended to be limited to the particular examples disclosed herein. Indeed, the present techniques include all alternatives, modifications, and equivalents falling within the true spirit and scope of the appended claims.

What is claimed is:

1. A computing system, comprising:
an electronic device comprising:
a controller; and
a new form factor (NFF) receptacle; and
a legacy-compatible adapter coupled to the NFF receptacle to couple the electronic device to a second electronic device,
the second electronic device comprising a legacy connector, and
the adapter comprising a voltage converter to convert voltage signals between the NFF receptacle of the electronic device and the legacy connector of the second electronic device.

2. The computing system of claim 1, wherein the legacy connector comprises one of a USB connector, a USB 2.0 connector, or a USB 3.0 connector.

3. The computing system of claim 1, wherein the adapter comprises a cable, the cable comprising a first end and a second end, the first end comprising the legacy connector and the second end comprising the NFF connector.

4. The computing system of claim 1, wherein the adapter is to couple a first electronic device comprising an NFF connector to a second electronic device comprising a legacy connector.

5. The computing system of claim 1, wherein the adapter comprises a state machine to enumerate capabilities of an electronic device coupled to the adapter.

6. The computing system of claim 1, wherein the legacy-compatible adapter comprises a new form factor (NFF) connector at a first end and a legacy connector at a second end, the legacy connector physically identical to the new form factor (NFF) connector, wherein the legacy connector is coupled to one of a new form factor (NFF) device or a legacy device, and wherein pins of the legacy connector are to be dynamically assigned to the NFF device or the legacy device.

7. The computing system of claim 1, wherein the NFF connector comprises an NFF plug and the legacy connector comprises one of a USB connector, a USB 2.0 connector, or a USB 3.0 connector.

8. A legacy-compatible adapter with backward compatibility, comprising:
a first surface comprising a legacy connector;
a second surface comprising a current new form factor (NFF) connector; and
a voltage converter to shift voltage signals between the legacy connector and the current NFF connector, wherein the legacy-compatible adapter couples an electronic device comprising a current new form factor (NFF) receptacle to a second electronic device comprising a legacy connector.

9. The legacy-compatible adapter of claim 8, wherein the legacy connector comprises one of a USB connector, a USB 2.0 connector, or a USB 3.0 connector.

10. The legacy-compatible adapter of claim 8, wherein the legacy connector comprises a legacy receptacle or a legacy plug.

11. The legacy-compatible adapter of claim 8, wherein the adapter comprises a cable, the cable comprising a first end and a second end, the first end comprising the legacy connector and the second end comprising the NFF connector.

12. The legacy-compatible adapter of claim 8, wherein the adapter is to couple a first electronic device comprising an NFF connector to a second electronic device comprising a legacy connector.

13. The legacy-compatible adapter claim 8, wherein the voltage converter comprises an active silicon in the NFF connector.

14. The legacy-compatible adapter of claim 8, wherein the adapter comprises a state machine to enumerate capabilities of an electronic device coupled to the adapter.

15. The legacy-compatible adapter of claim 8, wherein the NFF connector comprises an NFF plug and the legacy connector comprises one of a legacy plug and a legacy receptacle.

16. The legacy-compatible adapter of claim 15, wherein the first surface comprises a new form factor (NFF) connector and the second surface comprises a legacy connector at the second end, the legacy connector physically identical to the new form factor (NFF) connector, wherein the legacy connector is coupled to one of a new form factor (NFF) device or a legacy device, and wherein pins of the legacy connector are to be dynamically assigned to the NFF device or the legacy device.

17. A computing system, comprising:
logic to receive, in a controller of a host electronic device, notice of coupling of a second electronic device to the host electronic device, the second electronic device coupled to the host electronic device via a legacy-compatible adapter comprising a voltage converter;
logic to determine a protocol to use in communicating with the second electronic device; and
logic to establish a connection with the second electronic device to transfer data between the host electronic device and the second electronic device using the determined protocol.

18. The computing system of claim 17, further comprising:
logic to convert a voltage of a signal from a legacy voltage to a current NFF voltage when the second electronic device comprises a legacy connector.

19. The computing system of claim 17, wherein determining the protocol comprises determining if the second electronic device comprises a legacy connector or an NFF connector.

20. The computing system of claim 17, wherein the adapter comprises a first surface comprising an NFF connector and a second surface comprising a legacy connector.

21. The computing system of claim 20, wherein the NFF connector comprises an NFF plug and the legacy connector comprises one of a legacy plug and a legacy receptacle.

22. The computing system of claim 17, wherein the adapter comprises a cable comprising a first end and a second end, the first end comprising an NFF connector and the second end comprising a legacy connector.

23. The computing system of claim 17, wherein the second electronic device comprises a USB connector, a USB 2.0 connector, or a USB 3.0 connector.
